(19) United States
(12) Patent Application Publication
(10) Pub. No.: US 2003/0048148 A1
(43) Pub. Date: Mar. 13, 2003

(54) Method for tuning the response of RF and microwave devices

(76) Inventors: Richard G. Humphreys, Malvern (GB); Julian S. Satchell, Malvern (GB); Simon W. Goodyear, Malvern (GB)

Correspondence Address: NIXON & VANDERHYE P.C., 8th Floor, 1100 North Glebe Road, Arlington, VA, 22201, US

(21) Appl. No.: 09/950,818

(22) Filed: Sep. 13, 2001

(51) Int. Cl. H01P 7/08

(52) U.S. Cl. 333/99 S; 333/205; 333/219; 333/17.1; 505/210

(57) ABSTRACT

A method of tuning a microwave or RF circuit is given which comprises the steps of taking a microwave or RF circuit (20) located in a casing (57), said casing comprising a housing portion (32) and a window portion (50), said window portion (50) being substantially conducting at microwave/RF frequencies, and comprising at least one area that is substantially transparent at optical frequencies and, directing a laser beam (66) onto said microwave or RF circuit through said window portion (50) so as to alter the material properties of selected areas of said microwave or RF circuit (20). This permits microwave and RF circuits, including microwave filters, to be tuned without the need for tuning screws.

### BACKGROUND OF THE INVENTION

1. Field of the Invention

This invention relates to a method for tuning microwave and radio-frequency (RF) devices. More particularly, it relates to a method for tuning high temperature superconductor (HTS) microstrip microwave filter devices.

2. Description of Related Art

Microwave filters are commonly used in microwave transmitter/receiver systems to ensure the majority of radiation is within a certain frequency range. Precisely selecting a frequency range of radiation is particularly important in certain applications, such as cellular base-stations, which must operate within a tightly defined frequency band.

Conventionally, high performance microwave filters have been implemented using rather bulky waveguide structures. Microwave filters are also known which are fabricated from HTS, typically in a microstrip arrangement. HTS microstrip filters typically comprise a plurality of resonator elements fabricated from the superconductor material, and are significantly smaller in size than waveguide structures having equivalent or better performance. High temperature superconductors require cooling, typically to temperatures around 77K to become superconducting.

All high performance filters, both waveguide and HTS devices, generally require some degree of tuning after fabrication to compensate for design and manufacturing inaccuracies. Tuning a waveguide device typically involves making adjustments to the physical geometry of the waveguide structure, whilst HTS microstrip filters are generally tuned by adjusting the position of dielectric tipped screws in relation to the microstrip structure to vary the capacitance or inductance of the device.

Although distributed resonator models of microwave devices are available to those skilled in the art to aid the tuning process (see for example, G L Hey-Shipton in IEEE MTT-S digest, (1999), 1547), the adjustment of tuning screws is generally performed manually and is a difficult, time consuming process. The presence of the tuning screws also increases the overall package size of the filter, reduces it mechanical integrity and can limit the packing density of resonators in the filter layout.

A more complete discussion of HTS microwave filters and their properties can be found in chapter 5 of “Passive microwave device applications of high-temperature superconductors” by M J Lancaster, Cambridge University Press, 1997 (ISBN 0 521 48032 9).

It is an object of this invention to mitigate some of the disadvantages associated with tuning microwave or RF circuits, and in particular thin film HTS microstrip devices, that are described above.

### SUMMARY OF THE INVENTION

According to a first aspect of this invention, a method of tuning a microwave or RF circuit comprises the steps of taking a microwave or RF circuit located in a casing, said casing comprising a housing portion and a window portion, said window portion being substantially conducting at microwave/RF frequencies and comprising at least one area that is substantially transparent at optical frequencies and, directing a laser beam onto said microwave or RF circuit through said window portion so as to alter the material properties of selected areas of said microwave or RF circuit.

The requirement for the window portion to be substantially conducting at the microwave or RF frequency band of operation is to prevent any significant radiation loss from the microwave or RF circuit through the window portion of the casing. The window portion, or part thereof, should also be substantially transparent (i.e. transparent or semi-transparent at the appropriate laser frequency) so that it transmits sufficient laser radiation to alter the material properties of selected areas of the microwave or RF circuit.

The tuning of a microwave or RF circuit using this method has several advantages over the prior art tuning methods described above. For example, the requirement for tuning screws is removed. This lack of tuning screws decreases the package size of the device, increases its mechanical integrity and improves the packing density of such devices in a microwave/RF circuit.

Conveniently, the method also comprises the additional step of measuring the electrical response of said microwave or RF circuit. Advantageously, the electrical response is measured using a vector network analyzer.

In a further embodiment, the measured electrical response of the microwave or RF circuit may be used with a computer based model to select which areas of said microwave or RF circuit to alter the material properties of.

The step of measuring the electrical response before and/or during and/or after the material properties of selected areas of the circuit are altered is advantageous as it allows the tuning process to be accurately controlled. Unlike the prior art technique of manually adjusting tuning screws, the method of the first aspect of the present invention could also be automatically controlled by a computer that runs suitable device analysis and prediction software.

Advantageously, said window portion comprises a mesh of conductive material arranged on a substantially optically transparent substrate. The mesh of conductive material may comprise a regular, or irregular, array of conductive lines.

Conveniently, the conductive material may be a high temperature superconductor such as YBa₂Cu₃O_{7-δ} (YBCO), having a transition temperature of approximately 92K. If the HTS material used is YBCO, use of a compatible optically transparent substrate such as MgO is advantageous. Various techniques for the manufacture of appropriate HTS mesh structures would be known to those skilled in the art. Alternatively, the conductive material of the mesh is a normal metal. For example, gold.

In a further embodiment, said window portion comprises a sheet of conductive material shaped to define at least one hole therein. For example, a sheet of metal (e.g. gold) with holes drilled therein.

Conveniently, said at least one hole is located so as to allow said laser beam to be directed to certain areas of said circuit. Locating the holes in certain area of the window portion allows the material properties of selected areas of the microwave or RF circuit to be altered whilst minimizing loss of microwave or RF radiation through the window portion.

In a further embodiment said window portion comprises a continuous layer of metal semi-transparent at optical frequencies. For example, a thin continuous layer of gold could be coated on a transparent substrate. The gold layer should be sufficiently thick to act as a microwave or RF conductor so as to minimize loss of radiation through the window portion, and also sufficiently thin to allow the transmission of sufficient laser light to alter the properties of the selected areas of said microwave or RF circuit.

Advantageously, the method of tuning a microwave or RF circuit is performed on a microwave filter circuit. Such a circuit may be fabricated from high temperature superconductor, and conveniently the circuit cooled to the operating temperature of said high temperature superconductor whilst the material properties of selected areas of it are altered.

It is advantageous to perform trimming at the normal operating temperature of the circuit so that its characteristics may be continuously measured during trimming. In the case of a filter made of superconductor, this means cooling it significantly below the transition temperature of the superconductor, and stabilizing its temperature sufficiently accurately at the planned operating temperature that the circuit characteristics are well defined

In a preferred embodiment, said laser beam is directed onto said microwave or RF circuit and alters the material properties by laser ablation. A person skilled in the art would also appreciate the other ways in which the properties of the material could be altered (e.g. HTS could be deoxygenated).

According to a second aspect of this invention, a method of manufacturing a microwave or RF device comprises taking a microwave or RF device, tuning said microwave or RF device using the method according to the first aspect of this invention and replacing said window portion of said casing with a conductive cover portion. Advantageously, the cover portion is metal. For example, a sheet of metal plated with gold.

According to a third aspect of the present invention, a microwave or RF device is manufactured using a method of manufacture according to the second aspect of this invention.

Replacing the window portion with a conductive cover portion (e.g. a metal lid) after performing the tuning method of the first aspect of this invention is advantageous as it provides a method of manufacturing a tuned device that does not posses any tuning screws. In addition, the resultant microwave or RF device does not posses a window portion, thereby maximizing its mechanical robustness.

### BRIEF DESCRIPTION OF THE DRAWINGS

In order that the invention may be more fully understood, embodiments thereof will now be described, by way of example only, with reference to the accompanying drawings, in which;

FIG. 1 is a illustration of a microstrip filter having a single resonator circuit element;

FIG. 2 is a diagram of a microstrip filter having a plurality of resonator circuit elements;

FIG. 3 is a diagram of a housing apparatus for a multipole filter with adjustment screws to tune the filter response;

FIG. 4 shows a housing apparatus and a mesh lid that can be used in the present invention;

FIG. 5 shows apparatus for carrying out the method of this invention,

FIG. 6 represents experimental data showing the frequency response of a λ/2 resonator circuit located in housing apparatus using various types of lids;

FIG. 7 shows the effect of widening the gap in a λ/2 resonator circuit by laser ablation trimming; and

FIG. 8 shows how laser trimming can be used to optimize the response of a three section microstrip filter.

### DETAILED DESCRIPTION OF PREFERRED EMBODIMENTS

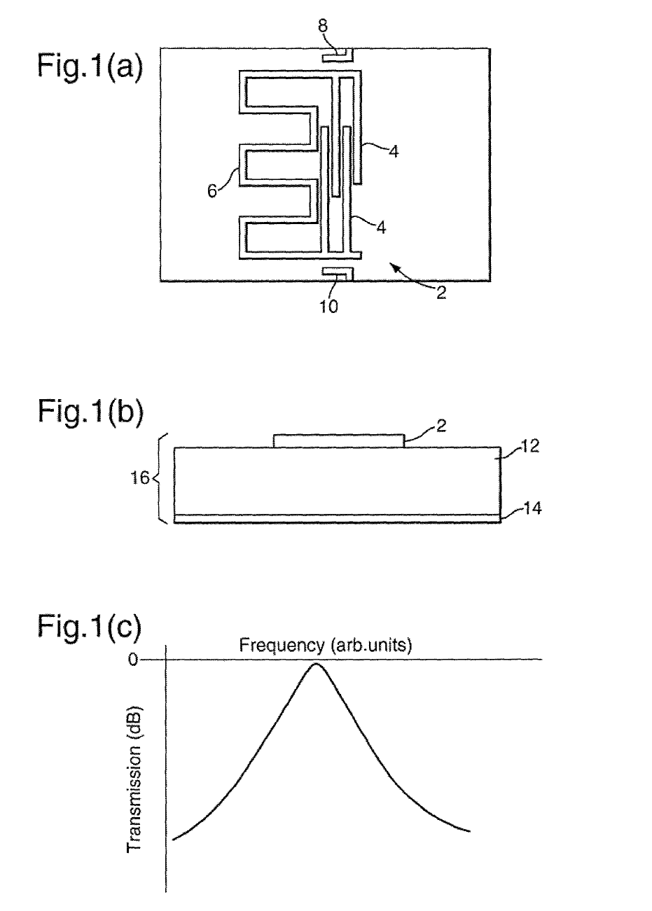

Referring to FIG. 1(a), a typical prior art microwave resonator circuit 2 is shown. The resonator consists of a number of interdigitated fingers 4 forming a capacitor, and a meandering structure 6 forming an inductor. In combination, the interdigitated fingers 4 and the meandering structure 6 form a parallel resonant circuit.

Referring to FIG. 1(b), the microwave resonator circuit 2 is generally formed on a substrate consisting of a layer of dielectric material 12 and a ground plane 14. The microwave resonator circuit 2, the layer of dielectric material 12 and the ground plane 14 are collectively termed a microstrip structure 16.

Typically, the microwave resonator circuit 2 and the ground plane 14 are formed from a HTS material. Although HTS materials require cooling (typically to around 77K), the low surface resistance of the HTS material greatly reduces the resistive losses of the circuit, compared with normal conducting material (such as gold or copper etc).

In operation, microwave radiation enters the resonator circuit 2 of the microstrip structure through the input connection 8. Microwave radiation exits through the output connection 10. The resonator circuit will only pass radiation that is within a frequency range centered around the resonant frequency of the particular circuit. The transmission versus frequency characteristic of a typical resonator circuit is illustrated in FIG. 1(c), and the design of the resonator circuit 2 will determine the frequency dependent transmission properties of the microstrip structure.

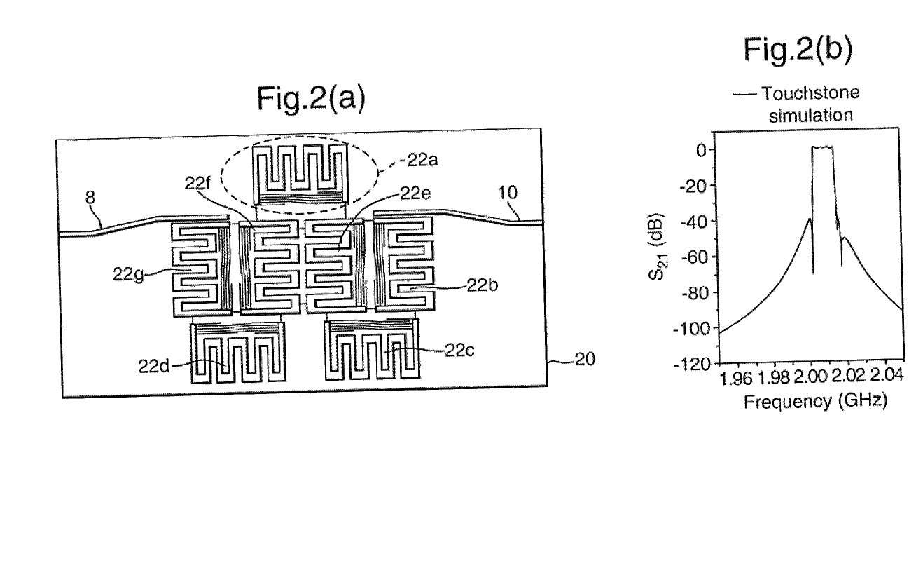

Referring to FIG. 2(a), a microstrip structure is shown with a resonator circuit 20 having a plurality (in this case seven) of circuit elements 22. Combining two or more resonator circuit elements in this manner, each having the same or slightly different resonant frequencies, allows a filter to be produced with controlled transmission over a broader range of frequencies. FIG. 2(b) shows the predicted microwave transmission response of the resonator circuit 20.

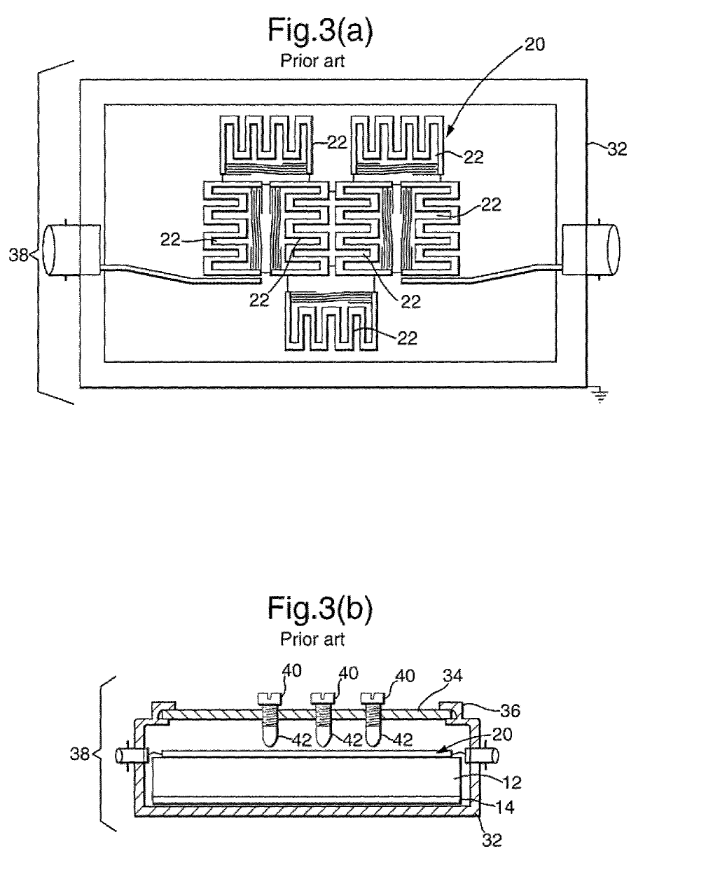

Referring to FIG. 3, the microstrip filter (comprising a resonator circuit 20, a dielectric layer 12 and a ground plane 14) is located in a metallic housing 32 that has a metal lid 34 attached thereto. The metal lid 34 is mechanically secured, and also electrically connected, to the metallic housing 32 using fixing means 36. The metallic housing 32, and metal lid 34, are electrically earthed thereby eliminating radiation loss from the filter. Hereinafter, a microstrip filter contained in a metallic housing is termed a microstrip filter device 38.

The Microstrip filter devices of the type shown in FIG. 3 is a band-pass filter. Generally, such band-pass filters are designed to have a uniform and high transmission across the desired band-width, a very low level of transmission outside the desired band-width and a sharp threshold between the transmission and non-transmission regions. In certain applications, such as cellular base-station receivers, these criteria are very precisely defined placing tight performance criteria on the microstrip filter device. In addition to the band-pass microstrip filter referred to above, a person skilled in the art would also appreciate the many other types of filter devices (e.g. band-stop filters etc) and applications where precise performance is also necessary. Typically, filters that are required to operate within very tight performance parameters are termed high performance filters.

To attain high performance from a microstrip filter requires very accurate resonator circuit designs to be produced. The resultant response of a resonator circuit arises not only from the individual characteristics of each resonator element, but also from inter-resonator coupling effects between the elements. The effect of the environment local to the microstrip structure, such as the properties of the housing, will also affects the resultant properties of the microstrip filter device.

Those skilled in the art have devised numerous models and techniques for designing microwave resonator circuits, and a discussion of circuit design criteria is provided in “Passive microwave device applications of high-temperature superconductors” by M J Lancaster, Cambridge University Press, 1997 (ISBN 0 521 48032 9). However, even the most advanced theoretical models known to those in the art are not capable of producing circuit designs with the accuracy required for high performance operation.

Even if precise modeling tools were available, device performance would be affected by any minute variations in the properties of the materials used in microstrip fabrication; for example, inhomogeneous variations in the material used to form the resonator circuit 20, the dielectric material of the dielectric layer 12 or the material from which the ground plane 14 is fabricated. In addition, any variations in the material properties of the difference pieces of material used when manufacturing a plurality of devices (for example substrate thickness differences) would also prevent high performance operation being consistently obtained for each device in a manufacturing batch.

At present, high performance is obtained from microstrip filter devices by “tuning” the device (i.e. changing the device response) after fabrication. Typically, tuning screws 40 with a dielectric tip 42 are located in the metal lid 34. Variation of the separation between the dielectric tip 42 and the resonator circuit 20 alters the capacitance and/or inductance associated with a particular portion of the resonator circuit 20, thereby slightly altering the overall resonant properties of the filter device. Each tuning screw 40 is generally arranged so as to be located in the vicinity of a particular circuit element 22, and each circuit element 22 usually has a tuning screw associated with it (although in FIG. 3 only three tuning screws are shown for clarity).

The microstrip filter device is typically tuned manually by an operator who adjusts the plurality of tuning screws whilst observing the response of the device on a vector network analyzer. This technique is time consuming, and generally requires an operator with experience of how each tuning screw will effect the overall device response. Tuning screws may also come loose during subsequent operation, thereby degrading the performance of the microstrip filter device over time.

Furthermore, the filter tuning process must be performed at the operating temperature of the device; which in the case of typical HTS material is around 77K. For HTS devices, a cryogenic temperature control device must therefore be provided which also allows access to the tuning screws of the microstrip filter device.

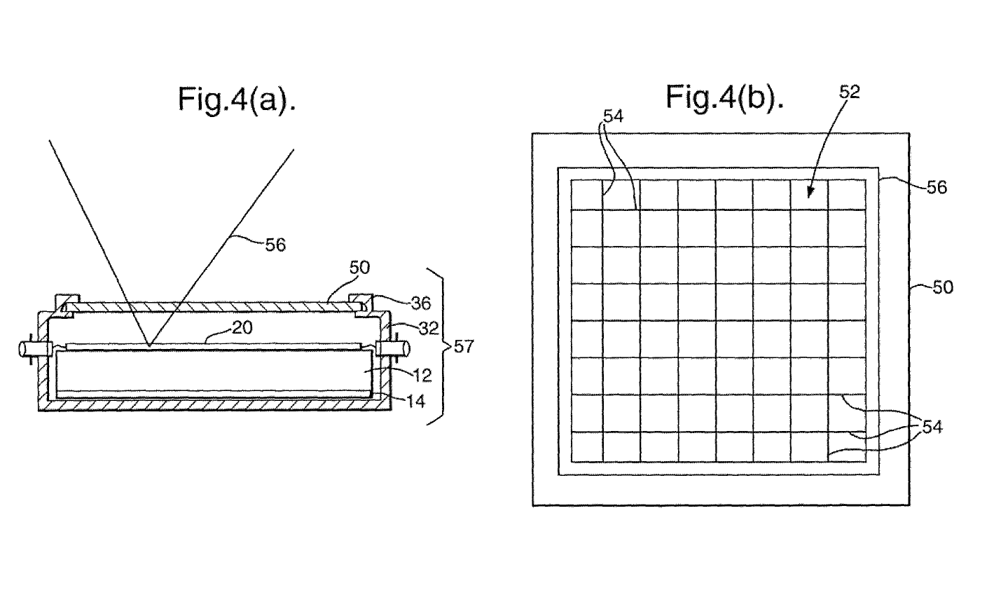

Referring to FIG. 4, a casing 57 is shown for tuning a HTS microwave filter using the method of the present invention. A mesh lid 50 comprises lines of conducting material 54 on a substantially optically transparent substrate 52. The mesh lid 50 is mechanically secured to the metallic housing 32 using fixing means 36. To ensure electrical connection between the metallic housing 32 and the lines of conducting material 54, a metallic contact rim 56 is provided.

The mesh structure that is formed from the lines of conducting material 54 could be fabricated using a plurality of techniques and materials that are well known to those skilled in the art; for example by use of photolithography or shadow mask techniques. The skilled person would also recognize the various types of substantially transparent substrate material that could be employed; a material such as quartz could be used as a substrate for the gold mesh, whilst a HTS mesh would require a compatible substrate material such as MgO.

The mesh lid 50 is substantially transparent at optical wavelengths, enabling a laser beam to be directed on to the resonator circuit 20 of the microstrip structure. The resonator circuit 20 can then be tuned by trimming away small areas of the circuit by laser ablation. In other words the layout of the resonator circuit 20, and hence the transmission versus frequency properties of the device, can be altered very slightly by removing small areas of the resonator circuit by laser ablation. It is also possible to change the properties of certain HTS materials by exposing to laser radiation which is of too low an intensity to cause ablation but which has an effect (e.g. by causing de-oxygenation) on the electrical properties of the material; this can also be used to tune the resonator circuit 20.

The mesh lid 50 should be located sufficiently far from the focal plane of the incident laser beam 56 so that the laser beam, which is focussed on the circuit, does not damage the mesh during the laser ablation process. Additionally it is preferable, although not essential, that the laser beam 56 passes through several holes in the mesh so that the intensity of laser light reaching the resonator circuit 20 is substantially independent of the position through which the laser light passes through the mesh lid 50.

Although an optically transparent substrate coated with lines of conducting material provides a convenient mesh lid, a person skilled in the art would recognize the many other types of mesh lid arrangements that are available. A wire gauze having a good electrical connection between the crossing wires would be a suitable alternative.

In fact any lid would suffice provided it is conducting at microwave frequencies (i.e. capable of preventing radiation loss from the device) and is also, at least in part, substantially optically transparent (i.e. allows a laser beam to pass through it or through parts of it). Examples of suitable lids that could be used instead of a mesh include a very thin continuous layer of normal metal (such as gold) that would provide a semitransparent layer. Alternatively, a metallic lid with an array of holes in it could be employed. In the latter case, the holes could either be evenly distributed across the lid, or concentrated only in areas of the lid associated with parts of the resonator circuit that may require trimming.

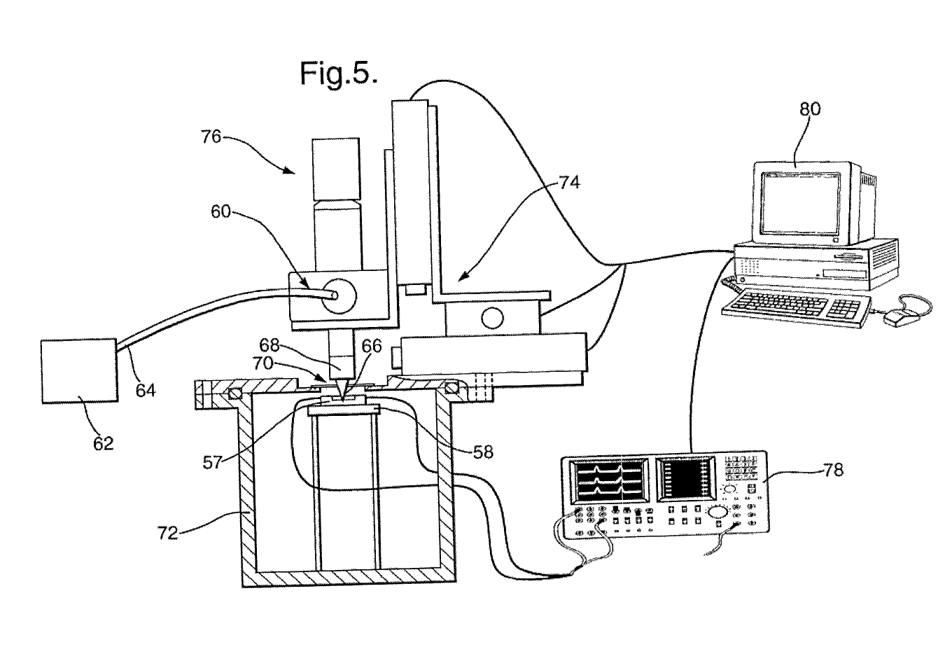

Referring to FIG. 5, a system for laser trimming the resonator circuit 20 of a microstrip filter is shown. The system comprises a miniature dye laser 60 mounted on the illuminator unit of an optical microscope. A pulsed UV laser 62 excites the dye cell 60 via a fiber optic cable 64 and the resultant laser beam 66 exits the microscope objective lens 68. The laser beam 66 has a diameter of around 5 mm at the objective lens.

The microstrip filter is located in a casing 57 of the type described with reference to FIG. 4. The casing 57 is located on a cooled stage 58 in a vacuum chamber 72. The stage is cooled by liquid nitrogen, allowing rapid cool down for trimming and warm-up afterwards. The resultant laser beam 66 passes through a quartz window 70 of the vacuum chamber 72 and is focussed to a spot size of approximately 2 μm in diameter on the resonator circuit 20 contained in the casing 57. The circuit mounting should be mechanically stable to an accuracy significantly less than the spot size. The resonator circuit 20 is located approximately 22 mm from the microscope objective lens 68. The resonator circuit 20 is also located approximately 1 cm from the mesh lid 50, and consequently the resultant laser beam is slightly greater than 2 cm in diameter when it passes through the mesh lid 50.

The microscope assembly is moved by a 3D micro-positioning stage 74, that allows a full movement range of ±20 mm from the window center. A video camera 76 mounted on the illuminator unit provides TV images of the device taken through the mesh lid.

The system described above allows specific areas of the resonator circuit to be removed by laser ablation, whilst the Vector Network Analyzer 78 continually monitors the properties of the microstrip filter device. The system can be operated with the resonator circuit cooled to the necessary operation temperature; typically around 77K for HTS material. The entire system is controlled by a computer 80.

The tuning of the resonator circuit may be performed by an operator who monitors the properties of the microstrip filter and ablates areas of the microstrip accordingly. The software may also allow comparison of the TV image with the designed filter layout, facilitating the identification of a region to be trimmed. Additionally, the computer 80 could be programmed with a suitable software model that predicts the areas of the microstrip filter that should be removed to attain the desired performance; in this way a fully automated tuning process could be implemented.

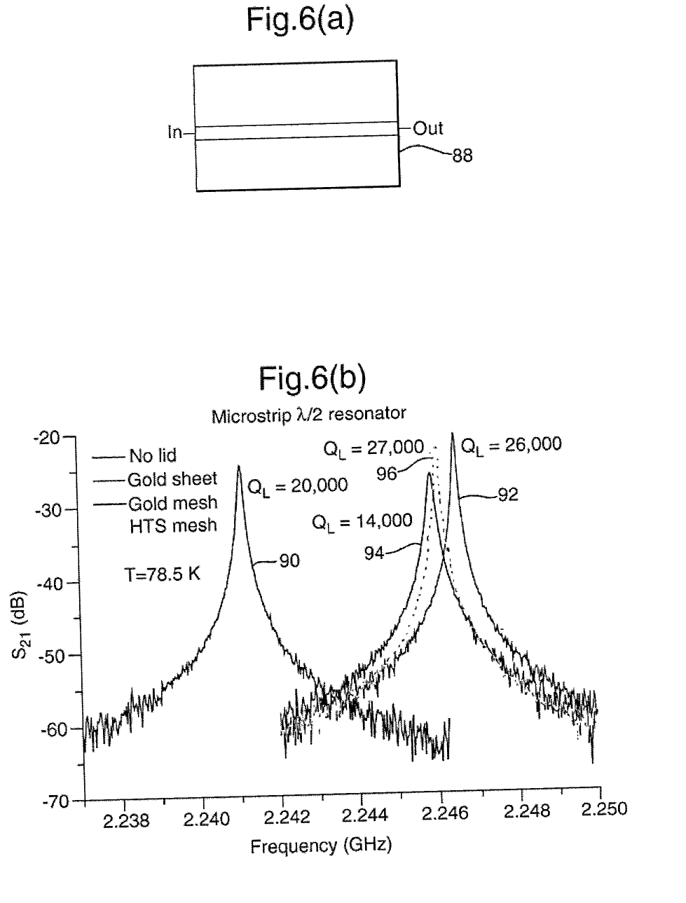

Referring to FIG. 6, experimental results are provided to demonstrate the effect of various lid arrangements on the properties of a microstrip filter placed in a metallic housing.

FIG. 6(a) shows a low impedance λ/2 resonator circuit 88 that was patterned on one side of a double sided YBCO/MgO wafer. The λ/2 resonator circuit 88 was placed in a metallic housing of the type described with reference to FIG. 4(a), and located on the cold stage 58 of the system described with reference to FIG. 5. The temperature inside the cryostat was then reduced to 78.5K.

The transmission dependent frequency properties of λ/2 resonator circuit 88 were measured with no lid on the metallic housing, and also with the metallic housing having lids fabricated from continuous gold sheet, gold mesh and HTS mesh.

FIG. 6(b) show a first curve 90 which shows the properties of the λ/2 resonator circuit 88 when placed in a metallic housing having no lid. The second curve 92 shows the frequency transmission properties of the λ/2 resonator circuit 88 when a lid consisting of a continuous gold sheet is used on the metallic housing.

The third curve 94 and the fourth curve 96 show the frequency response of the circuit when the metallic housing is provided with gold mesh and HTS mesh lids respectively. The gold mesh lid comprised 25 μm strips of gold separated by 1 mm spaces and gave an optical transmission of approximately 95%, and the HTS mesh comprised 25 μm strips of HTS separated by 500 μm and provided an optical transmission of around 90%. The mesh structures were both formed on optically transparent substrates, the gold being on quartz and the HTS being on MgO. It can be seen that for undemanding applications a normal metal mesh is adequate although a HTS mesh performs better.

The response of the filter when the housing lacks a lid can be seen to be substantially different to the properties of the device when a continuous or mesh lid is attached. The effective surface resistance of the mesh, which is approximately the surface resistance of the material forming the mesh divided by the fraction of the surface are covered in conductor, is the main factor that determines where the peak response of the filter occurs. The small frequency shift of the type observed with the mesh lids is generally acceptable and, as it can be accurately quantified, is easily correctable. This allows a metal lid to placed on the housing once tuning of the filter has been performed using the mesh lid.

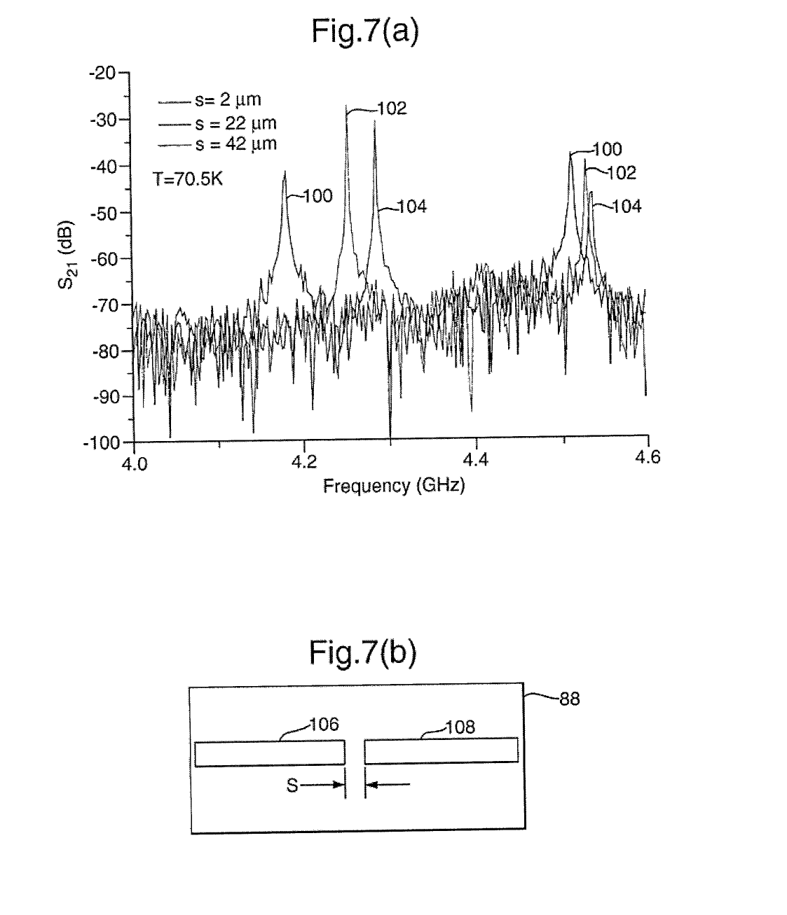

Referring to FIG. 7, the effect of trimming away sections of material from a λ/2 resonator circuit 88 is shown. The λ/2 resonator circuit 88 was placed in the system described with reference to FIG. 5, and the laser was used to cut an approximately 2 μm gap across the middle of a λ/2 resonator circuit 88. It was found that surface melting of the HTS material forming the circuit had no effect on the response of the resonator, and that full ablation was required to achieve electrical isolation between the two parts of the resonator. In the regime between surface melting and full ablation, the material became lossy and the Q of the resonant peak was substantially reduced. When the resonator had been cut in two, there was no measurable loss associated with the fully ablated region.

Once two separate resonator arms 106; 108 had been formed, as shown in FIG. 7(b), the frequency dependent transmission response shown in the first curve 100 of FIG. 7(a) was observed. The physical separation between the two resonator arms was increased from 2 μm to 22 μm by laser trimming, producing the frequency response of the second curve 102. Further laser trimming to separate the resonator arms by 42 μm resulted in the third curve 104. It can thus be seen that the resonant frequency of a simple λ/2 resonator circuit can be accurately tuned by laser trimming parts of the circuit through the mesh lid.

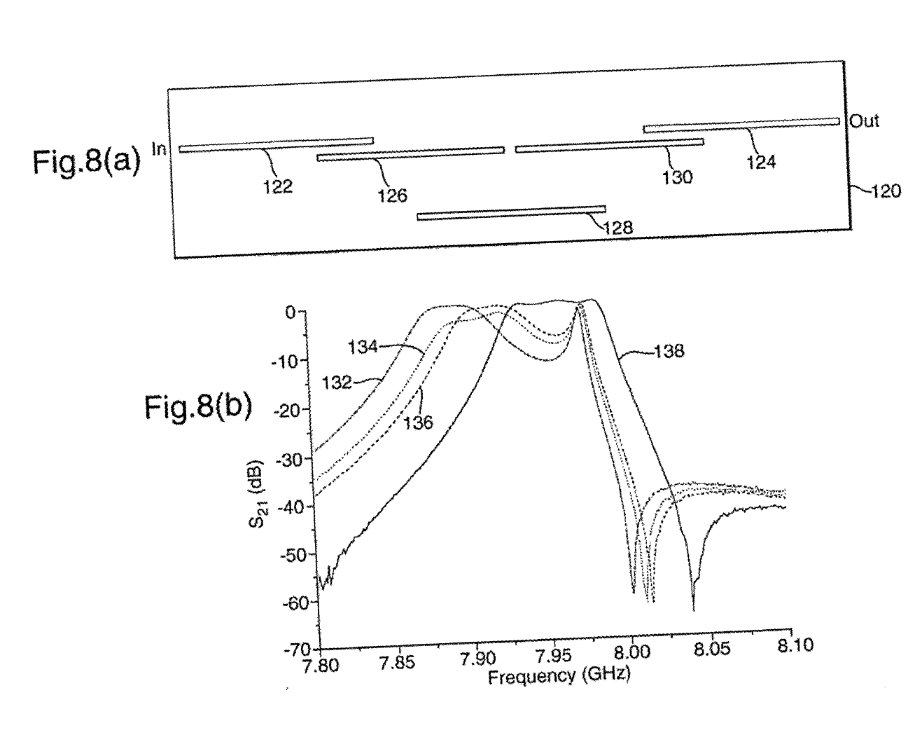

Referring to FIG. 8(a), a three section pseudo-elliptic filter 120 is shown that comprises a plurality of simple λ/2 resonators. The filter circuit comprises an input line 122 and an output line 124, a first resonator 126, a second resonator 128, and a third resonator 130. The device was fabricated from a 2.5×2.5 cm² double sided YBCO/MgO wafer, and the device layout was initially designed using Touchstone (™) software that is commercially available from Eesof Inc., 5601 Lindero Canyon Rd, Westlake Village, Calif. 91362.

A series of laser trimming operations were performed on the filter, and after each trim the data was analyzed to determine the next trim operation. The only readily adjustable parameters of this circuit were the input couplings, the resonator frequencies and the cross-coupling between the input and output resonators. The couplings can only be reduced, while it is easier to increase the resonator frequencies that to reduce them. In this example, only the first and third resonators were tuned; the second resonator was considered as fixed.

To optimize the trim process, the measured filter response data were fitted to a distributed resonator model of the type described by G L Hey-Shipton in IEEE MTT-S digest, (1999), 1547. A prediction was then made to assess the change in filter parameters that was required to produce a tuned response, based on the resonator model and extrapolated changes in it matrix elements. The filter was then trimmed, filter response data were acquired and the analysis/prediction process was repeated.

FIG. 8(b) shows the various frequencies responses as the three section pseudo-elliptic filter 120 was tuned by laser trimming, using the iterative trim process described above. The first curve (132), the second curve (134) and the third curve (136) correspond to successive trim operations on the first and third resonators. After further trim operations, the final filter response (138) was obtained. The final laser trimmed filter had a bandwidth of 54 MHz at 7.958 GHz, with a maximum in-band insertion loss of approximately 0.9 dB.

The laser tuning of a microstrip filter, through a mesh lid, using the process described above provides an efficient design, fabrication and manufacture process without the need for bulky tuning screws. Using this laser tuning technique, the prototyping of filters can be made more efficient by reducing the need for mask iteration, making it practical to fabricate one-off filters for specialist applications. As software improvements are made, automated tuning after production would reduce costs and improve filter performance as the design could be optimized to account for the specific characteristics of each device.

Once the filter has been tuned, the mesh lid may be replaced with a solid metallic lid with only an insignificant or predictable effect on the response of the filter. The use of a metal lid after tuning ensures greater mechanical robustness of the filter device, with minimum detriment to performance.

Although the above embodiments describe microwave devices, and in particular microwave filters, a person skilled in the art would recognize that this tuning method could be used to tune any microwave circuit. For example, the properties of monolithic microwave integrated circuits (MMICs) could also be tuned using this technique. A skilled person would also recognize that, in addition to being used at microwave frequencies (which herein is taken to include mm-wave and sub-mm wave frequencies), the technique is equally applicable to tuning radio frequency (RF) devices.

We claim

1. A method of tuning a microwave or RF circuit comprising the steps of:
taking a microwave or RF circuit located in a casing;
said casing comprising a housing portion and a window portion;
said window portion being substantially conducting at microwave/RF frequencies, and comprising at least one area that is substantially transparent at optical frequencies; and
directing a laser beam onto said microwave or RF circuit through said window portion so as to alter the material properties of selected areas of said microwave or RF circuit.

2. A method of tuning a microwave or RF circuit as claimed in claim 1 and comprising the additional step of measuring the electrical response of said microwave or RF circuit.

3. A method of tuning a microwave or RF circuit as claimed in claim 2 wherein the electrical response is measured using a vector network analyzer.

4. A method of tuning a microwave or RF circuit as claimed in claim 2 and comprising the additional step of analyzing the electrical response of said microwave or RF circuit and using a computer based model to select the areas of said microwave or RF circuit for material property alteration.

5. A method of tuning a microwave or RF circuit as claimed in claim 1 wherein said window portion comprises a mesh of conductive material arranged on a substantially optically transparent substrate.

6. A method of tuning a microwave or RF circuit as claimed in claim 5 wherein said conductive material is a superconductor.

7. A method of tuning a microwave or RF circuit as claimed in claim 6 wherein said superconductor is YBCO.

8. A method of tuning a microwave or RF circuit as claimed in claim 7 wherein said substantially optically transparent substrate is MgO.

9. A method of tuning a microwave or RF circuit as claimed in claim 5 wherein said conductive material is metal.

10. A method of tuning a microwave or RF circuit as claimed in claim 1 wherein said window portion comprises a sheet of conductive material shaped to define at least one hole therein.

11. A method of tuning a microwave or RF circuit as claimed in claim 10 wherein said at least one hole is located so as to allow said laser beam to be directed to certain areas of said circuit.

12. A method of tuning a microwave or RF circuit as claimed in claim 1 wherein said window portion comprises a continuous layer of metal semi-transparent at optical frequencies.

13. A method of tuning a microwave or RF circuit as claimed in claim 1 wherein said microwave or RF circuit is a microwave filter circuit.

14. A method of tuning a microwave or RF circuit as claimed in claim 1 wherein said microwave or RF circuit is a fabricated from high temperature superconductor.

15. A method of tuning a microwave or RF circuit as claimed in claim 14 wherein tuning is performed with said microwave or RF circuit cooled to the operating temperature of said high temperature superconductor.

16. A method of tuning a microwave or RF circuit as claimed in claim 1 whereby directing said laser beam onto said microwave or RF circuit alters the material properties by laser ablation.

17. A method of tuning a microwave or RF circuit as claimed in claim 1 and comprising the additional step of using a video camera to visually monitor the microwave or RF circuit

18. A method of manufacturing a microwave or RF device comprising;
taking a microwave or RF device;
tuning said microwave or RF device using the method as claimed in claim 1; and
replacing said window portion of said casing with a conductive cover portion.

19. A method of manufacturing a microwave or RF device as claimed in claim 18 wherein said conductive cover portion is metal.

20. A microwave or RF device manufactured using the method of claim 18.
